(19) United States
(12) Patent Application Publication
(10) Pub. No.: US 2008/0280152 A1
(43) Pub. Date: Nov. 13, 2008

(54) Fireproof Molded Articles or Materials and Method for the Production Thereof

(75) Inventors: Christos G. Aneziris, Freiberg (DE); Jana Hubalkova, Freiberg (DE)

Correspondence Address: THE WEBB LAW FIRM, P.C., 700 KOPPERS BUILDING, 436 SEVENTH AVENUE, PITTSBURGH, PA, 15219, US

(73) Assignee: TECHNISCHE UNIVERSATAT BERGAKADEMIE FREIBERG, Freiberg (DE)

(21) Appl. No.: 12/091,956

(22) PCT Filed: Oct. 27, 2006
(86) PCT No.: PCT/DE2006/001911

§ 371 Date: Jul. 2, 2008

(30) Foreign Application Priority Data
Oct. 29, 2005 (DE) 10 2005 051 953.9

(51) Int. Cl. C04B 35/01; C04B 35/04; C04B 35/043; C04B 35/532; C04B 35/66

(52) U.S. Cl. 428/471; 264/29.1; 428/698

(57) ABSTRACT

The invention relates to fireproof molded articles or materials as well as a method for obtaining a high-strength binding phase in magnesium oxide, aluminum oxide, zirconia mullite, zirconium dioxide, magnesium aluminate spinel, bauxite, yttrium oxide, silicon carbide, silicon nitride, or boron nitride products, or mixtures of carbon-bonded products, such as pressed carbon-bonded rocks, carbon-bonded slide plates or carbon-bonded submerged nozzles or cast carbon-containing and/or carbon-bonded products or carbon-bonded stoppers, which have improved mechanical, thermal, and chemical properties. The binding matrix of the fireproof molded articles or materials contains titanium carbide phases and/or titanium carbonitride phases. The fireproof molded articles or materials are composed of oxidic and/or non-oxidic and/or carbon-containing fireproof grains based on a carbonized mixture and a binding agent to which fine-grained titanium dioxide, ilmenite, FeTiO₃, CaTiO₃, MgTiO₃, BaTiO₃, or a combination thereof, or additional particles of one or several elemental metals are added.

The invention relates to fireproof moulded articles or materials as well as to a method for obtaining a high-strength binding phase in magnesium oxide, aluminium oxide, zirconia mullite, zirconium dioxide, magnesium aluminate spinel, bauxite, yttrium oxide, silicon carbide, silicon nitride, boron nitride products or mixtures of carbon-bonded products, such as pressed carbon-bonded bricks, carbon-bonded slide plates or carbon-bonded submerged nozzles or cast carbon-containing and/or carbon-bonded products or carbon-bonded stoppers, which have improved mechanical, thermal and chemical properties. The method according to the invention can also be used for the production of fireproof products without carbon additives.

Carbon-bonded products find wide application as linings in metallurgical vessels, such as for example carbon-bonded magnesia bricks in the converter, or key components, such as for example submerged nozzles or slide plates or stoppers or casting channels within the continuous casting area. Carbon-bonded fireproof products are also used within the blast furnace area in transporting vessels, such as for example ladles, or in the chemical industry or the waste incineration industry as temperature-resistant pipes, or in the cement industry as lining material. Phenolic resins, such as for example resols or novolaks, synthetic coal-tar, such as for example carbores, or natural coal-tar or bitumen, preferably serve as binders. Metal additives, such as for example Si or Al or Mg, are predominantly used for optimizing the oxidation resistance of carbon-containing products.

German published patent application DE 199 54 893 A1 discloses carbon-bonded products with improved oxidation behaviour. By adding a catalytically active substance from the group of readily reducible compounds of the transition elements, in particular metallocenes or metallobenzoates or metallonaphthenates of copper, chrome, nickel or iron to the synthetic resin components, a crystalline highly graphitised carbon is produced under 1000° C., which helps to improve chemical properties.

In the publication “Effect of refractory oxides on the oxidation of graphite and amorphous carbon” by Akira Jamaguchi et al in J. Amer. Ceram. Society, graphite and amorphous carbon, without binding agents, are mixed together with Al₂O₃, MgO, Ti₂ and ZrO₂ and examined in respect to their “exothermy” by means of thermal analysis up to 1000° C.

The outstanding corrosion, erosion, abrasion and oxidation properties of the TICN phase have been known from the coatings of metal tools by CVD (chemical vapour deposition) since the 90s (“Bland structures of substoichiometric titanium nitrides and carbonitrides: spectroscopical and theoretical investigations”, M. Guemmaz, G. Moraitis, J. Phys: Condens. Matter 9 (1997) 8453-8463). However, up to then no consideration had been given to also using such titanium compounds for the production of fireproof moulded articles.

For the users of fireproof moulded articles at high application temperatures, in particular above 1500° C., however, more improved mechanical, thermal and chemical properties are worth striving for in order to increase the operational life of the highly stressed fireproof products.

DE 199 35 251 A1 discloses the use of TiO₂-containing particulate materials as additives for fireproof products, wherein the TiO₂-containing materials are added to the mixture of aggregates and binding agents. In this case the crystalline TiO₂ remains in the product. When penetrated by liquid slag or melt the TiO₂ fraction is dissolved and reacts to form titanium nitride or titanium carbonitride. This reaction influences both the stability of this fireproof product and also the slag or melt contacting this product.

EP 1 275 626 A1 discloses carbon-bonded fireproof materials, which are made from a mixture of 5-85% by weight carbon, 5-15% by weight aluminium oxide or a mixture of aluminium oxide and other materials, 5-15% by weight metallic silicon, 5-20% by weight Ti, TiN, TiCN and/or TiC. Binding agents are added to this starting mixture, which is then kneaded, formed and pressed to form a moulded article, which is then fired at 1250° C. Regardless of the fact that the Ti-additives are expensive, the crystalline Ti-additive remains preserved in the fireproof materials.

The object of the invention is to create fireproof moulded articles or materials with or without carbon additives, which are thermoplastically deformable and in addition have an improved thermo-mechanical and oxidation behaviour as well as a high-strength binding phase.

According to the invention the object is achieved by fireproof moulded articles or materials based on a carbonized mixture of oxidic and/or non-oxidic and/or carbon-containing fireproof grains and a binding agent, to which fine-grained titanium dioxide or ilmenite or FeTiO₃ or CaTiO₃ or MgTiO₃ or BaTiO₃ or a combination thereof, or additionally particles of one or more elementary metals are added, and wherein the binding matrix contains titanium carbide phases and/or titanium carbonitride phases.

The adding of fine-grained titanium dioxide or ilmenite or FeTiO₃ or CaTiO₃ or MgTiO₃ or BaTiO₃ or additionally particles of one or more elementary metals leads to a high-strength binding matrix with titanium carbide phases and/or titanium carbonitride phases of the fireproof moulded articles or materials according to the invention. If additionally particles of one or more elementary metals are added, apart from titanium carbide phases and/or titanium carbonitride phases, the binding matrix also contains crystalline metal carbides and/or metal oxicarbides. Compared with the prior art, titanium carbide phases and/or titanium carbonitride phases, and with added metal also the metal carbides and/or metal oxicarbides, stabilize the fireproof moulded articles or materials according to the invention in high temperature use.

The particles of one or more metals are selected from Al, Si, Ti, Mg, Fe, Mo and/or W. Apart from direct addition to the binding agent, it is also possible to add the particles to the mixture of fireproof grains and binding agents.

The oxidic fireproof grains consist of magnesium oxide or aluminium oxide or zirconia mullite or zirconium dioxide or magnesium aluminate spinel or bauxite or yttrium oxide or mixtures of these oxides.

The non-oxidic fireproof grains consist of silicon carbide or silicon nitride or boron nitride or their mixtures.

The carbon-containing fireproof grains consist of graphite and/or soot.

In an advantageous embodiment of the invention the composition of the fireproof moulded articles or materials is based on a carbonized mixture of magnesium oxide and a binding agent, to which fine-grained titanium dioxide and elementary aluminium are added, wherein their binding matrix contains titanium carbide phases and/or titanium carbonitride phases as well as titanium carbide (TiC), aluminium carbide (Al₄C₃) and aluminium titanium carbide (Al₂Ti₄C) and aluminium oxicarbide (Al₂° C.) at carbonizing temperatures up to 1000° C. At higher carbonizing temperatures above 1500° C. the binding phase contains stable, crystalline titanium carbide and aluminium carbide phases.

According to the invention the fireproof moulded articles or materials are made from a mixture of oxidic and/or non-oxidic and/or carbon-containing fireproof grains and a binding agent based on synthetic resin and/or bitumen and/or synthetic coal-tar and/or natural coal-tar. In this case fine-grained titanium dioxide or ilmenite or FeTiO₃ or CaTiO₃ or MgTiO₃ or BaTli₃, or additionally particles of one or more elementary metals are added to the binding agent and the mixture is carbonized at a temperature, at which titanium carbide phases and/or titanium carbonitride phases and/or metal carbide and/or metal oxicarbide and/or further carbides and/or oxycarbides, dependent on the added metal, are produced in situ in the binding matrix.

If titanium dioxide is solely added to the binding agent, the carbonizing temperature is higher than 1200° C. Further titanium carbide phases and/or titanium carbonitride phases also form at higher temperatures or during application at the operating temperatures.

If ilmenite and/or FeTiO₃ and/or CaTiO₃ and/or MgTiO₃ and/or BaTiO₃, with or without TiO₂, are added to the binding agent, the carbonizing temperature is less than 1200° C., preferably less than 1000° C.

In an advantageous embodiment of the method according to the invention particles of one or more elementary metals, selected from Al, Si, Ti, Y, Mg, Fe, Mo or W are added to the mixture and/or the binding agent. In order to produce the binding matrix with titanium carbide phases and/or titanium carbonitride phases, the carbonizing temperature is less than 1200° C.

The oxidic fireproof grains consist of magnesium oxide or aluminium oxide or zirconia mullite or zirconium dioxide or magnesium aluminate spinel or bauxite or yttrium oxide or mixtures of these oxides.

The non-oxidic fireproof grains consist of silicon carbide or silicon nitride or boron nitride or their mixtures.

The carbon-containing fireproof grains consist of graphite and/or soot.

Fine-grained titanium dioxide and/or ilmenite and/or FeTiO₃ and/or CaTiO₃ and/or MgTiO₃ and/or BaTiO₃, in a maximum quantity of 2 W by weight, preferably 0.3 to 1.5% by weight, are added to the binding agent.

The elementary metal is added in a maximum quantity of 3% by weight, preferably 1 to 2% by weight, related to the mixture used.

According to the invention, fine-grained titanium dioxide (TiO₂) or fine-grained, titanium-containing raw materials or fine-grained, titanium-containing materials with or without a metal based on Al, Mg, Si, Ti, Fe, Y or mixtures thereof, are added to the binding agent based on synthetic resin, bitumen or synthetic coal-tar or natural coal-tar or mixtures thereof and are mixed with further graphite grains with or without soot and with varying fractions of fireproof oxides, such as for example MgO or Al₂O₃ or ZrO₂, in an intensive mixer and converted into products by means of pressing or casting with or without the addition of water, plasticizer or cement. According to the invention, after carbonizing at up to 1000° C. or after a carbonizing process between 1300 and 1500° C., the products receive a binding phase, which possesses outstanding mechanical, thermal and chemical properties. Ilmenite, FeTiO₃, CaTiO₃, MgTiO₃ and BaTiO₃ serve as titanium-containing raw materials or titanium-containing materials. In the case of iron titanates or titanium iron ores both reactions for the production of graphite below 1000° C. and reactions for the production of the titanium carbide and/or titanium carbonitride in the binding phase may be preferred.

The adding of fine-grained titanium dioxide and/or ilmenite and/or FeTiO₃ and/or CaTiO₃ and/or MgTiO₃ and/or BaTiO₃ and additionally particles of one or more elementary metals solely to the binding agent leads to a high-strength binding matrix of the fireproof moulded articles or materials produced according to the invention with titanium carbide phases and/or a titanium carbonitride phases or additionally with metal carbide and/or metal oxicarbide in the case of added metal. Compared with the prior art, the titanium carbide phases and/or titanium carbonitride phases and/or metal carbides and/or metal oxicarbides produced in situ in the binding matrix improve the mechanical, thermal and chemical properties of the fireproof moulded articles or materials according to the invention in high temperature use. Additionally, they increase their creep stability.

With fireproof products the binding phase is the weakest link in the structure. According to the invention, according to the way proposed the binding phase is reinforced by the addition of these additives to the binding agent and by the formation of these phases in the binding matrix. The phases produced also remain, according to the invention, crystalline at higher carbonizing or application temperatures. At higher carbonizing temperatures above 1500° C. stable, crystalline titanium carbide and metal carbide phases form.

The grain size of the titanium dioxide and/or the ilmenite and/or the FeTiO₃ and/or the CaTiO₃ and/or the MgTiO₃ and/or the BaTiO₃ is less than 5 μm, preferably less than 2 μm.

The particle size of the added metal is between 5 to 150 μm.

In an advantageous embodiment of the method according to the invention the fireproof moulded articles or materials are produced based on a mixture of magnesium oxide and a binding agent, to which fine-grained titanium dioxide and elementary aluminium are added, and carbonized at up to 1000° C. The moulded articles or materials produced in this way contain titanium carbide phases and/or titanium carbonitride phases as well as titanium carbide (TiC), aluminium carbide (Al₄C₃) and aluminium titanium carbide (Al₂Ti₄C) and aluminium oxicarbide (Al₂OC) in the binding matrix.

Exemplary embodiments of the invention are described below in detail:

The advantageous mechanical, thermal and chemical properties according to the invention are demonstrated on the basis of carbon-bonded magnesium oxide products for metallurgical applications in the converter. Cylindrical laboratory samples 50 mm in diameter and 50 mm in height are produced from three mixtures by means of unidirectional pressing at a pressure of 120 MPa. The mixtures are listed in Table 1.

In mixture 2 (Table 1) according to the invention titanium carbonitride (TiC_{0.7}N_{0.3}) forms in the binding phase with a small quantity of un-reacted titanium dioxide at an application temperature above 1300° C. with the sole addition of TiO₂ without added metal. Starting from 1500° C., according to the invention, only titanium carbonitride (TiCN) exists in the binding phase, which imparts substantially higher oxidation resistance, mechanical strength and thermal shock resistance to the carbon-bonded product, compared with a synthetic resin-bonded product having only added aluminium.

In mixture 3 (Table 1) according to the invention at a temperature above 1000° C. with the addition of TiO₂ and metal based on aluminium, titanium carbide (TiC), aluminium carbide (Al₄C₃) and aluminium titanium carbide (Al₂Ti₄C) and aluminium oxicarbide (Al₂° C.) form. At higher temperatures and in particular at 1500° C. according to the invention the binding phase predominantly consists of aluminium carbide and titanium carbide. These two phases in the binding matrix, according to the invention, already starting from 1000° C. impart a substantially higher oxidation resistance, mechanical strength and thermal shock resistance to the carbon-bonded product, compared with a synthetic resin-bonded product having solely aluminium-containing additives.

Mixture 1 is a comparison mixture according to the prior art.

TABLE 1
Composition of mixtures 1, 2 and 3.

| | Mixture 1 | | Mixture 2 | | Mixture 3 | |
|---|---|---|---|---|---|---|
| | | Weight | | Weight | | Weight |
| Material | % | [g] | % | [g] | % | [g] |
| MgO 2-4 mm | 20.5 | 615 | 20.16 | 604.80 | 20.16 | 604.80 |
| MgO 1-2 mm | 32.5 | 975 | 32.43 | 972.90 | 32.43 | 972.90 |
| MgO 0-1 mm | 22.0 | 660 | 21.91 | 657.30 | 21.91 | 657.30 |
| MgO (meal) | 13 | 390 | 13.15 | 394.50 | 13.15 | 394.50 |
| Graphite | 12 | 360 | 11.95 | 358.50 | 11.95 | 358.50 |
| TiO₂ < 1 μm | — | — | 0.40 | 12.00 | 0.4 | 12 |

Related to approx. 3,000 gr.

| | | | | | | |
|---|---|---|---|---|---|---|
| Aluminium | 2.5 | 75 | — | — | 2.5 | 75 |
| Novolak | 2.2 | 66 | 2.2 | 66 | 2.2 | 66 |
| (Synthetic | | | | | | |
| resin) | | | | | | |
| Hexa | 0.22 | 6.6 | 0.22 | 6.6 | 0.22 | 6.6 |
| (Synthetic | | | | | | |
| resin) | | | | | | |
| Carbores | 1.0 | 30 | 1.0 | 30 | 1.0 | 30 |
| (Synthetic | | | | | | |
| coal-tar) | | | | | | |

Table 2 shows, after carbonization at 1000° C., the open porosities, the cold compressive strengths and the oxidation depths following an oxidation test in oxygen atmosphere at 1200° C. and after 3 hours.

TABLE 2
Properties of mixtures 1, 2 and 3.

| | Mixture 1 | Mixture 2 | Mixture 3 |
|---|---|---|---|
| Open porosity | 13.04 | 13.1 | 11.3 |
| in [Vol. %] | | | |
| Cold | 22 | 23 | 32 |
| compressive | | | |
| strength in | | | |
| [MPa] | | | |
| Oxidation | 8-10 | 2-3 | 1-2 |
| depth in [mm] | | | |

Mixtures 2 and 3 have substantially smaller oxidation depths and mixture 3 additionally outstanding strength. The mechanical, thermal and chemical properties of mixtures 2 and 3 having the titanium dioxide addition in the binding agent are particularly further reinforced at the high application temperatures above 1500° C. due to the pronounced formation, at higher temperatures, of the very consistent titanium carbide phases and titanium carbonitride phases in the binding matrix. Depending upon the fireproof system the sole addition of titanium dioxide can impart considerable advantages to the fireproof product due to the substantially higher oxidation resistance and stability of the titanium carbonitride phase, in comparison with the aluminium carbide phase.

FIG. 1 shows a REM (scanning electron microscope) photograph of a misalignment of the carbonized mixture 2 with TiCN phases. The grain size of the TiCN produced in-situ lies in the nanometer range. This also imparts high strength to the binding phase, which is therefore reinforced mechanically and thermo-mechanically.

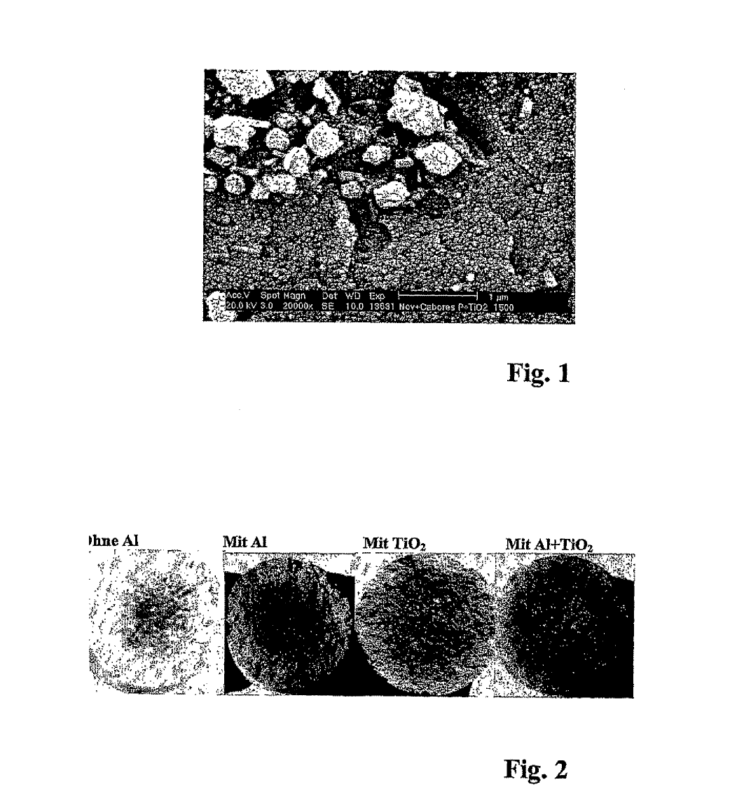

FIG. 2 shows MgO-C carbon-bonded products, carbonized at 1000° C. and after an oxidation resistance test at 1200° C. in air for 3 hours, (from left to the right) MgO-C product based on novolak binding agent without additives, with addition of Al, with addition of TiO₂ and with addition of Al and TiO₂. The decarburisation/oxidation depth is reduced by means of the sole addition of TiO₂. The oxidation resistance is further reinforced by combination of the addition of TiO₂ and Al. Virtually no signs of decarburisation are visible.

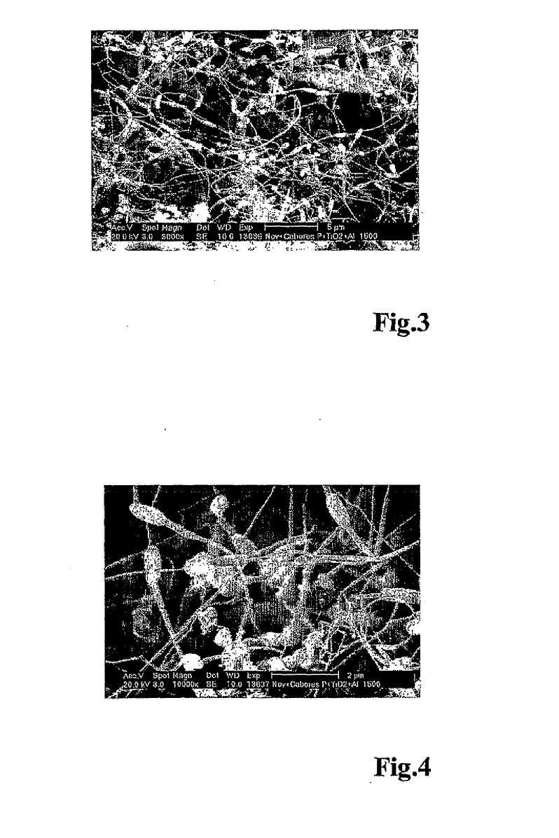

FIG. 3 and FIG. 4 show REM (scanning electron microscope) photographs of fracture surfaces of the binding matrix from mixture 3 with additions of Al and TiO₂. The dumbbell-shaped structures forming from aluminium carbide, aluminium oxicarbide and titanium carbide impart outstanding thermo-mechanical properties including oxidation and corrosion resistance to the fireproof products.

1. Fireproof moulded articles or materials comprising a carbonized mixture of at least one of oxidic, non-oxidic and carbon-containing fireproof grains and a binding agent, wherein fine-grained titanium dioxide or ilmenite or FeTiO₃ or CaTiO₃ or MgTiO₃ or BaTiO₃, or a combination thereof, or additionally particles of one or more elementary metals, are added to the binding agent, and wherein the binding agent contains at least one of titanium carbide phases and titanium carbonitride phases.

2. The fireproof moulded articles or materials according to claim 1, wherein the particles of one or more elementary metals are selected from Al, Si, Ti, Mg, Fe, Mo or W, and the binding matrix further contains at least one of metal carbides and metal oxicarbides.

3. The fireproof moulded articles or materials according to claim 1, wherein the oxidic fireproof grains consist of magnesium oxide or aluminium oxide or zirconia mullite or zirconium dioxide or magnesium aluminate spinel or bauxite or yttrium oxide or mixtures of these oxides, the non-oxidic fireproof grains consist of silicon carbide or silicon nitride or boron nitride or their mixtures, and the carbon-containing fireproof grains consist of at least one of graphite and soot.

4. A method for the production of fireproof moulded articles or materials from a mixture of at least one of oxidic, non-oxidic, and carbon-containing fireproof grains with a binding agent based on at least one of synthetic resins, bitumen, synthetic coal-tar, and natural coal-tar, wherein at least one of fine-grained titanium dioxide, ilmenite, FeTiO₃, CaTiO₃, MgTiO₃, and BaTiO₃ are added to the binding agent, and the mixture is carbonized at a temperature, at which titanium carbide phases or titanium carbonitride phases are produced in the binding agent.

5. The method according to claim 4, wherein with the sole addition of titanium dioxide the carbonizing temperature is higher than 1200° C.

6. The method according to claim 4, wherein with the addition of at least one of ilmenite, FeTiO₃, CaTiO₃, MgTiO₃, and BaTiO₃ with or without TiO₂ the carbonizing temperature is less than 1200° C.

7. The method according to claim 4, wherein additional particles of one or more elementary metals, selected from Al, Si, Ti, Y, Mg, Fe, Mo or W are added to the mixture or the binding agent, the mixture is carbonized to 1000° C., wherein at least one of titanium carbide phases and titanium carbonitride phases and at least one of metal carbides and metal oxicarbides are produced in the binding agent.

8. The method according to claim 4, wherein the oxidic fireproof grains are magnesium oxide, aluminium oxide, zirconia mullite, zirconium dioxide, magnesium aluminate spinel, bauxite or yttrium oxide or mixtures of these oxides, the non-oxidic fireproof grains are silicon carbide, silicon nitride, boron nitride or mixtures thereof, and the carbon-containing fireproof grains consist of at least one of graphite and soot.

9. The method according to claim 4, wherein at least one of fine-grained titanium dioxide, ilmenite, FeTiO₃, CaTiO₃, MgTiO₃, and BaTiO₃, in a maximum quantity of 2% by weight, are added to the binding agent.

10. The method according to claim 7, wherein particles of one or more elementary metals in a maximum quantity of 3% by weight, related to the mixture, are added to the binding agent or the mixture.

11. The method according to claim 4, wherein the mixture is formed and pressed before carbonizing in order to produce moulded articles.

12. The method according to claim 4, wherein the grain size of the titanium dioxide, the ilmenite, the FeTiO₃, the CaTiO₃, the MgTiO₃, or the BaTiO₃ is less than 5 μm.

13. The method according to claim 7, wherein the particle size of the added metal is 5 μm to 150 μm.

14. The use of a fireproof moulded article or a fireproof material according to claim 1 for carbon-bonded or carbon-containing products.

15. The use according to claim 14, wherein the carbon-bonded products are pressed carbon-bonded bricks, carbon-bonded slide plates or carbon-bonded submerged nozzles or cast carbon-containing products or carbon-bonded stoppers.
